(19) United States
(12) Patent Application Publication
(10) Pub. No.: US 2010/0012498 A1
(43) Pub. Date: Jan. 21, 2010

(54) METHOD FOR THE MANUFACTURE OF A THIN-LAYER BATTERY STACK ON A THREE-DIMENSIONAL SUBSTRATE

(75) Inventors: Rogier Adrianus Henrica Niessen, Eindhoven (NL); Petrus Henricus Laurentius Notten, Eindhoven (NL); Freddy Roozeboom, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/374,398

(22) PCT Filed: Jul. 11, 2007
(86) PCT No.: PCT/IB2007/052767

§ 371 Date: Jan. 20, 2009

(30) Foreign Application Priority Data
Jul. 25, 2006 (EP) 06117780.4

(51) Int. Cl. C25D 7/00; H01M 4/02

(52) U.S. Cl. 205/50; 205/57

(57) ABSTRACT

The invention relates to a method for the manufacture of a thin-layer battery stack on a three-dimensional substrate. The invention further relates to a thin-layer battery stack on a three-dimensional substrate obtainable by such a method. Moreover, the invention relates to a device comprising such a battery stack. The method according to the invention provides a rapid way to manufacture battery stacks on three-dimensional substrate, and the obtained products are of superior quality.

### FIELD OF THE INVENTION

The invention relates to a method for the manufacture of a thin-layer battery stack on a three-dimensional substrate. The invention further relates to a thin-layer battery stack on a three-dimensional substrate obtainable by such a method. Moreover, the invention relates to a device comprising such a battery stack.

### BACKGROUND OF THE INVENTION

Thin-layer battery stacks on three-dimensional substrates are manufactured through the deposition of functional layers (anode, cathode, solid electrolyte) by chemical vapor deposition (CVD) or physical vapor deposition (PVD) methods. The CVD and PVD techniques are relatively time-consuming and require high-tech, expensive equipment. Although flat (two-dimensional, 2D) substrates are most common, for some applications three-dimensional (3D) substrates are preferred. However, most of the CVD and PVD methods are unsuitable for deposition on 3D substrates, yielding unsatisfactory results. Low-pressure chemical vapor deposition (LPCVD) may be used for 3D substrates, but there are limitations to the aspect ratios of the three-dimensional substrates that can be satisfactorily covered. The aspect ratio is a measure for the mean depth of cavities in a material divided by the mean width of the entrance to those cavities.

The object of the invention is to provide an improved method for the manufacture of a thin-layer battery stack on a three-dimensional substrate.

### SUMMARY OF THE INVENTION

The invention provides a method for the manufacture of a thin-layer battery stack on a three-dimensional substrate, comprising the process steps:

a) application of a fluid comprising at least one precursor to the substrate,

b) exposure to a reduced pressure of the substrate and the fluid applied to the substrate, and

c) conversion of the precursor into a layer of the battery stack. This method enables the rapid formation of functional layers of a battery stack on a three-dimensional substrate. The method may be performed with relatively simple and cheap equipment.

Refraining from the exposure to reduced pressure in step b) will increase the time needed to sufficiently cover the three-dimensional substrate with the fluid, and also may lead to a lower quality of the produced layer. The precursor or mix of precursors is suitable for forming a layer material using known sol-gel techniques. The precursors are typically metal-organic compounds, metal salts and/or metallic coordination complexes of the desired elements, or monomers suitable for the formation of polymers. The fluid may be a solution of the precursor, or a dispersion such as a homogeneous colloidal suspension. During the exposure of the treated surface to a reduced pressure, the fluid surprisingly rapidly spreads into the cavities of the three-dimensional substrate. The exposure time to reduced pressure varies with the type of substrate and viscosity of the fluid. The reduced pressure is typically achieved by a vacuum pump system connected to a gas-tight container holding the substrate and the precursor fluid. The conversion of the film into a layer material is typically achieved by common sol-gel techniques, such as a heat treatment and/or polymerization steps. Excess fluid is usually removed prior to the conversion step, such that the conversion is merely performed in a film of the fluid that remains on the substrate.

Preferably, the application of the fluid in step a) is at least partly performed by dip coating. Dip coating is the immersion of at least part of the substrate into the fluid, which is a very thorough and reliable way to apply fluid to the substrate.

In another preferred embodiment, the application of the fluid in step a) is at least partly performed by spray coating. Spray coating is a very rapid and effective way to cover a three-dimensional substrate with fluid. Subsequent exposure to reduced pressure enables the rapid spreading of the fluid into the cavities of the structure, even at relatively high aspect ratios.

Advantageously, during step b) at least part of the substrate is submerged in the fluid. This method results in very rapid and reliable covering of the three-dimensional substrate with fluid, in particular at relatively high aspect ratios. Submerging is comparable to dip coating.

In a preferred embodiment, the aspect ratio of the three-dimensional substrate is at least 10, preferably at least 30, more preferably at least 50. Application of a thin layers for battery stacks to substrates with an aspect ratio higher than 10 is very time-consuming by conventional techniques such as LPCVD. Aspect ratios of 30 or even 50 have not been achievable with the conventional methods.

It is preferred if at least one layer of the battery stack is prepared according to the process steps, wherein the layer is selected from the group consisting of an anode layer, a cathode layer and a solid electrolyte layer. The other layers may be applied by conventional deposition techniques, if the aspect ratio allows this.

Most preferably, at least the anode layer, the cathode layer and the solid electrolyte layer of the battery stack are prepared according to the process steps. Other functional layers such as current collectors may also be applied by the technique according to the invention.

Preferably, for at least one of the layers of the battery stack, the conversion comprises a heat treatment of a heat-convertible precursor. Heat treatments are relatively easy to perform and to control, and can be performed rapidly.

In a preferred embodiment, the heat treatment comprises the steps of:

d) evaporation of solvent from the fluid to yield a gel layer comprising the heat-convertible precursor, and

e) annealing of the gel layer to form a layer by heating. Temperature during the evaporation step (also known as gelation step) is usually near the boiling point of the solvent. Typical solvents are alcohols such as ethanol, propanol or isopropanol. The evaporation may be performed under reduced pressure in order to lower the boiling point. Usually, the temperature during the annealing step is higher than during the evaporation step. During annealing the precursor is converted into the layer material.

In another preferred embodiment, for at least one of the layers of the battery stack, the conversion involves the polymerization of a monomer into a polymer. This is in particular useful when a polymer material is used as the solid electrolyte layer in a battery stack. Suitable layers to construct in this way are for instance polymer electrolytes such as polyethyleneoxide (PEO) and polysiloxane. Such polymers may be applied using the appropriate monomer solution as a precursor fluid. The conversion of the monomers to polymers may be performed by various techniques, depending on the monomer, for instance by a heat treatment or irradiation to yield radicals that initiate polymerization.

In another preferred embodiment, for at least one of the layers of the battery stack, the fluid is a polymer solution, and the conversion involves the evaporation of a solvent from the polymer solution to yield the polymer as a material layer. In particular polymer electrolyte layers, such as polyethyleneoxide (PEO) and polysiloxane may be applied using a polymer solution as a precursor fluid.

In another preferred embodiment, for at least one of the layers of the battery stack, the fluid is an electroplating solution, and the conversion involves the electroplating of a metal precursor from that solution to yield a metal layer. For instance, the electroplating solution is a solution of a platinum compound, which yields a platinum layer in an electrochemical conversion step by using the substrate as an electrode that is plated. Other metal layers may be applied in this way, for instance lithium, copper, silver and gold. Of course, the substrate should be an electrically conductive material in order to be able to apply this method.

In another preferred embodiment, the steps a), b) and c) are repeated multiple times with the same precursor solution to yield a layer of predetermined thickness. Thus, layers of a single material constitution and of the desired thickness are easily obtained. Each layer in the battery stack has its own optimal thickness, depending on the application in which it is used.

The invention also provides a thin-layer battery stack on a three-dimensional substrate, obtainable by the method according to the invention. Such batteries based on high aspect ratios of the three-dimensional substrate are relatively compact batteries compared to two-dimensional (flat) batteries, and may have a relatively large area of each layer, which reduces the internal resistance of the battery. It is preferred if the method is applied in the manufacture of a battery stack, wherein the anode layer, the solid electrolyte layer and the cathode layer are applied using the steps a), b) and c), using the appropriate precursors for each layer. Thus, the whole battery stack may be manufactured in a rapid way, using only relatively simple equipment. Such a battery stack is relatively cheap and reliable.

The invention also relates to a device comprising a thin-layer battery stack on a three-dimensional substrate, according to the invention. Such an electrical device confers the advantages of the battery stack according to the invention.

The invention will now be further elucidated by the following examples:

### BRIEF DESCRIPTION OF THE DRAWINGS

FIG. 1a-d shows an embodiment of the method according to the invention.

FIGS. 2a and 2b show products of the method according to the invention.

### DETAILED DESCRIPTION OF EMBODIMENTS

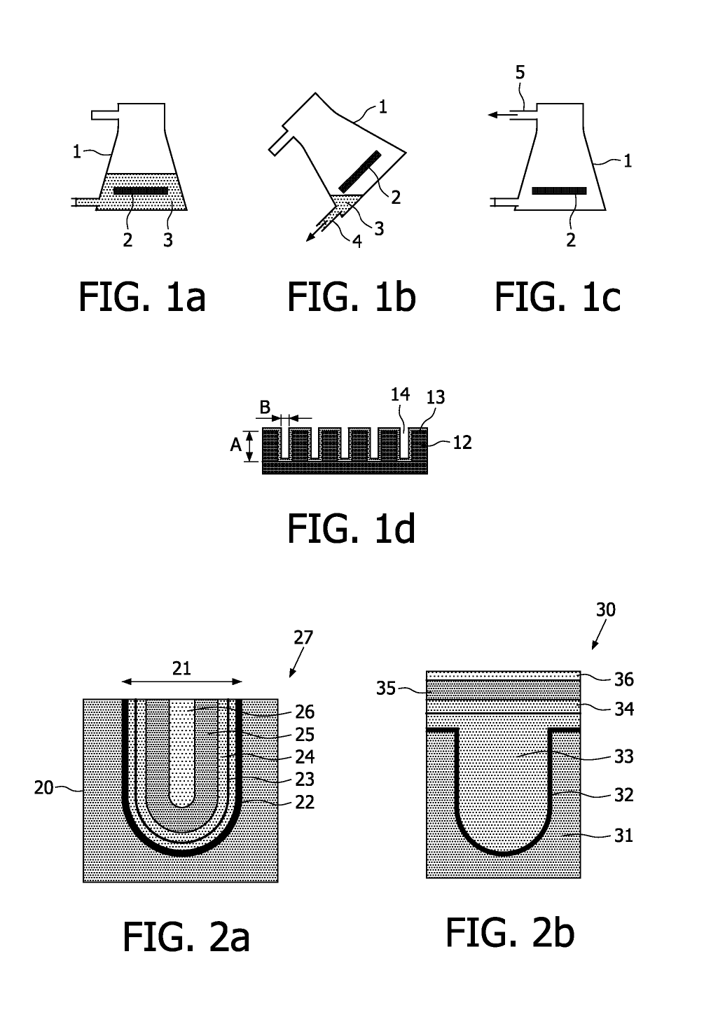

FIG. 1a shows a closed vessel 1 wherein a substrate 2 with a three-dimensional structure is immersed in a precursor fluid 3. The three-dimensional structure may include for instance holes, trenches and/or other cavities in various forms, usually introduced into the substrate material by etching. The precursor or precursors in the fluid 3 may be transformed in a later step into a material layer on the substrate using a sol-gel technique. After immersion in the fluid, the pressure within the vessel 1 is reduced by removing gas from the vessel 1 through an exhaust 5 connected to the vessel. The application of vacuum causes the rapid uptake of the fluid into cavities of the substrate. A sufficient level of wetting of the cavities of the substrate is usually achieved within 1 to 5 minutes, depending on fluid viscosity and aspect ratio of the cavities in the substrate 2. Without the application of vacuum, the wetting of the cavities of the substrate 2 would take at least 30 minutes, up to a few hours. After application of the vacuum, FIG. 1b shows the removal of the bulk of the fluid 3 through a channel connected to the vessel 1. A fraction of the fluid 3 remains adhered to the substrate. The resulting three-dimensional substrate 12 is depicted in FIG. 1d). A thin layer 13 of the precursor fluid 3 covers the interior surface of the cavities of the substrate 12. For clarity, the cavities 14 of the substrate 12 are shown here with a relatively low aspect ratio, wherein the aspect ratio is the depth of the cavity A, divided by the width B of the opening of the cavity. However, the method according to the invention results a satisfactory coverage of the surface for three-dimensional structures with aspect ratios of higher than 30 and even higher than 50. Sufficient coverage of cavities with such aspect ratios is practically not possible with conventional techniques. The fluid-covered substrate 12 is subsequently subjected to sol-gel methods, wherein the precursor in converted into a material layer. Further functional layers of the battery stack may then be applied using the same steps with the appropriate precursor fluid. Alternatively, the same precursor fluid may be used in order to achieve a thicker layer of the same material. The sol-gel technique typically comprises a temperature treatment involving the steps of evaporation of a solvent from the fluid in order to obtain a gel layer, followed by an annealing step at increased temperature, which transforms the gel layer into a solid material layer. However, for some functional layers of a thin film battery stack, in particular for electrolyte layers, the preferred layer may be a polymer material. Such layers may be achieved by applying a polymer solution using the method according to the invention. By removing the solvent, the polymer layer is deposited on the substrate. Another possibility is to use a monomer solution, which is applied using the method according to the invention, and subsequently the monomers are polymerized on the substrate.

FIG. 2a shows a silicon substrate 20 comprising a trench 21 wherein a number of layers that form a battery stack were applied using the method according to the invention as explained in FIGS. 1a-d. A first layer 22 is a cathode current collector, which was deposited by low-pressure chemical vapor deposition. Other methods to achieve such layers are for instance electroplating from a solution. On top of the cathode current collector, the cathode material 23 was added in multiple cycles of the method according to the invention in order to obtain the desired thickness. The next layer is a solid electrolyte layer 24, also applied by the method according to the invention. On top of the solid electrolyte layer 24 is an anode material layer 25, which connects to the anode current collector 26. Thus, a complete battery stack 27 is obtained in a three-dimensional structure. The position of the cathode 23 and the anode 24 is arbitrarily chosen. If only physical or chemical vapor deposition methods would have been used for the manufacture of the battery stack, the production time would have been multiple times longer. The method according to the invention thus improves the production time and results in more reliable battery stacks. The advantage in production time is most pronounced if all layers of the battery stack are produced by the method according to the invention.

FIG. 2b shows a battery stack 30 similar to the one in FIG. 2a, wherein only the cathode current collector 32 and the cathode material layer 33 are arranged in the three-dimensional trench etched in the silicon substrate 31, whereas the adjacent solid electrolyte layer 34, anode material layer 35 and the anode current collector 36 are all arranged in substantially flat, two-dimensional layers. Battery stacks 30 based on three dimensional substrates 31 such as shown in FIG. 2b have an improved resistance to expansion strain in the battery stack 30. Expansion strain may occur during due to increased temperatures during and differences in expansion coefficients of the different layers, and volume changes due to ion migration that occurs for instance in lithium ion batteries.

Li₄Ti₅O₁₂, V₂O₅, SnO₂ and NiVO₄ are anode materials that are readily obtainable as layers through sol-gel methods. Between the anode and cathode, a suitable solid electrolyte was deposited. Examples of solid electrolyte materials readily obtainable by sol-gel methods are Li₅La₃Ta₂O₁₂, Li_{0.5}La_{0.5}TiO₃, LiTaO₃ and LiNbO₃. LiCoO₂ is a cathode material that is particularly convenient to obtain as a layer by the sol-gel method according to the invention. Other examples of cathode materials are LiNiO₂ and LiMn₂O₄. Combined with a suitable solid electrolyte between the anode and the cathode material, well packed, stable layer stacks are obtained.

Table I shows an example of different precursors that may be employed in order to obtain a complete battery stack by means of by sol-gel methods. The annealing temperatures for these materials vary from 200° C. to 750° C., depending on the components.

TABLE I

| Layer Material | Precursor(s) | solvent |
|---|---|---|
| SnO₂ | Sn(OEt)₂ | ethanol |
| | or SnCl₂ | |
| LiNbO₃ | Nb(OEt)₅ and | 2-methoxyethanol |
| | Li or Li(OEt) | or ethanol |
| | | or propanol |
| LiCoO₂ | Co(CH₃CO₂)₂ | isopropanol |
| | Li(OC₃H₇) | acetic acid |

For a person skilled in the art, many variations and combinations of the examples according to the inventions are possible.

1. A method for the manufacture of a thin-layer battery stack (27, 30) on a three-dimensional substrate (2, 12 20, 31), comprising the steps of:
a) applying a fluid comprising at least one precursor to the substrate,
b) exposing to a reduced pressure of the substrate and the fluid applied to the substrate, and
c) converting the precursor into a layer of the battery stack, wherein the aspect ratio of the three-dimensional substrate is at least 10.

2. Method according to claim 1, characterized in that the application of the fluid (3) in step a) is at least partly performed by dip coating.

3. Method according to claim 1, characterized in that the application of the fluid (3) in step a) is at least partly performed by spray coating.

4. Method according to claim 1, characterized in that during step b), at least part of the substrate (2, 12, 20, 31) is submerged in the fluid (3).

5. Method according to claim 1, characterized in that the aspect ratio of the three-dimensional substrate is at least 30.

6. Method according to claim 1, characterized in that at least one layer of the battery stack (27, 30) is prepared according to the process steps, wherein the layer (23, 24, 25, 33, 34, 35) is selected from the group consisting of an anode layer (25, 35), a cathode layer (23, 33) and a solid electrolyte layer (24, 34).

7. Method according to claim 6, characterized in that at least the anode layer (25, 35), the cathode layer (23, 33) and the solid electrolyte layer (24, 24) of the battery stack (27, 30) are prepared according to the process steps.

8. Method according to claim 1, characterized in that for at least one of the layers (23, 24, 25, 33, 34, 35) of the battery stack (27, 30), the conversion comprises a heat treatment of a heat-convertible precursor.

9. Method according to claim 8, characterized in that the heat treatment comprises the steps of
d) evaporation of solvent from the fluid (3) to yield a gel layer (13) comprising the heat-convertible precursor, and
e) annealing of the gel layer (13) to form a layer (23, 24, 25, 33, 34, 35) by heating.

10. Method according to claim 1, characterized in that
for at least one of the layers of the battery stack (27, 30), the fluid (3) comprises a monomer, and the conversion involves the polymerization of the monomer into a polymer.

11. Method according to claim 1, characterized in that for at least one of the layers of the battery stack (27, 30), the fluid (3) is a polymer solution, and the conversion involves the evaporation of a solvent from the polymer solution to yield the polymer as a material layer (23, 24, 25, 33, 34, 35).

12. Method according to claim 1, characterized in that for at least one of the layers of the battery stack (27, 30), the fluid (3) is an electroplating solution, and the conversion involves the electroplating of a metal precursor from that solution to yield a metal layer.

13. Method according to claim 1, characterized in that the steps a), b) and c) are repeated multiple times with the same precursor solution to yield a layer (23, 24, 25, 33, 34, 35) of a predetermined thickness.

14. Thin-layer battery stack (27, 30) on a three-dimensional substrate (2, 12 20, 31), obtainable by the method according to claim 1.

15. Device comprising a thin-layer battery stack (27, 30) on a three-dimensional substrate (2, 12 20, 31) according to claim 14.
